(19) United States
(12) Patent Application Publication
(10) Pub. No.: US 2005/0033751 A1
(43) Pub. Date: Feb. 10, 2005

(54) Web service management leveraging a single process service framework

(76) Inventor: Jonathan Maron, Marlton, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/636,122

(22) Filed: Aug. 7, 2003

(51) Int. Cl. G06F 17/00

(52) U.S. Cl. 707/100

(57) ABSTRACT

A system and method for providing process management services in an enterprise application are disclosed comprising at least one remote Web service, the method comprising registering available process management objects associated with the at least one remote Web service with a process management object server (PMOS) at the enterprise application, the process management objects comprising at least one process management service, receiving, at the enterprise application, a request for the at least one process management service, communicating, from the PMOS, the request for the at least one process management service to the process management object, and returning process management information from the process management object responsive to the request.

### CROSS-REFERENCE TO RELATED APPLICATIONS

The present application is related to filed, co-pending, and commonly assigned U.S. patent application Ser. No. ______, Attorney Docket No. 100202434-1, entitled “SYSTEM AND METHOD FOR A CONFIGURATION REPOSITORY,” the disclosure of which is hereby incorporated herein by reference.

### DESCRIPTION OF RELATED ART

An enterprise application is a qualitative term used to describe a software application designed to execute under relatively demanding performance criteria and to support a relatively large number of distributed users in a scalable manner. The development of enterprise applications may be relatively difficult due to their robust functionality and performance requirements. Enterprise applications are typically implemented utilizing an application server architecture. The various services of the application server architecture are deployed on the application server by writing the software code (e.g., the object oriented class files) on a storage device associated with the application server and by modifying an appropriate deployment descriptor. In general, all of the modular software functionality of an application server is stored locally on the processing platform that executes the application server.

In addition to conventional application servers, distributed Web servers may be developed to enable remote services to be assembled into an application. Various protocols have been developed for the purpose of implementing remote Web services such as the Web Services Description Language (WSDL). WSDL defines interfaces and invocation methods of a Web service. WSDL basically tells what the Web service can do, where it resides, and how a client invokes it. The location and identification of Web services may occur utilizing Universal Description, Discovery, and Integration (UDDI). Communication with Web services may utilize various protocols such as remote procedure calls (RPC). For example, JAX-RPC is the JAVA™ remote procedure call technology. JAX-RPC enables JAVA™ developers to build Web applications and Web services. The RPC mechanism enables a remote procedure call from a client to be communicated to a remote server. In a distributed client/server model, for example, a server defines a service as a collection of procedures that are callable by remote clients. A client calls the remote procedures on the server to access services defined by the server. In extensible mark-up language (XML) based RPC, a remote procedure call is represented using an XML-based protocol such as the Simple Object Access Protocol (SOAP) 1.1 specification which defines a convention for representation of remote procedure calls and responses.

Web services are the infrastructure services or applications that provide some component or functionality to an overall, complete solution delivered via the Internet. For example, a Web service may encapsulate or utilize a database. The client may submit a request that a search of the database be performed and a keyword to search for. The Web service then searches the database and returns the search result to the requesting client. Web services may be simple, such as a service that returns a stock quote, or complex, such as a service that allows users to make car rental reservations or complete a loan application. Electronic services (e-services) are the complete solution delivered via the Internet that may use several Web services. Web and e-services are proliferating across the Internet driving e-commerce and business-to-business (B2B) commerce.

At present, more and more Web and e-services are being offered on the Web. There is a great rush to develop Web services and make them available to the vast clientele on the Internet. Developers are in constant need of better methods, tools, etc. for developing and implementing Web services. Assembling a distributed Web service can be extremely complex and unreliable. However, once a Web service has been made available for business, it is difficult to track its performance. Therefore, it becomes difficult for a company to manage its commodities. If a company only has a single Web service, the task would generally not be very demanding. However, considering that a Web service could perform only a small piece of logic, companies could conceivably have thousands of different Web services to manage across a wide network. Because the mere presence of Web services is extremely new, there are few, if any, management tools in place that can readily manage Web services.

### BRIEF SUMMARY OF THE INVENTION

Representative embodiments are directed to a method for providing process management services in an enterprise application comprising at least one remote Web service, the method comprising registering available process management objects associated with the at least one remote Web service with a process management object server (PMOS) at the enterprise application, the process management objects comprising at least one process management service, receiving, at the enterprise application, a request for the at least one process management service, communicating, from the PMOS, the request for the at least one process management service to the process management object, and returning process management information from the process management object responsive to the request.

Additional representative embodiments are directed to a system for providing process management resources to an application implementing distributed services comprising a controlled run-time environment within the application controlling execution of the distributed services, a management resource registry for registering distributed process management resources associated with the distributed services, and a resource interface enabling communication between the application and the distributed process management resources.

Additional representative embodiments are directed to a computer program product having a computer readable medium with computer program logic recorded thereon, the computer program product comprising code for registering available management information objects (MIOs) disposed in one or more remote Web services with a management object server (MOS) in an enterprise application, the MIOs comprising at least one process management service, code for receiving a request for the at least one process management service at the MOS, code for communicating the request for the at least one process management service from the MOS to the MIOs, and code for returning management information to the MOS responsive to the request.

### BRIEF DESCRIPTION OF THE DRAWINGS

FIG. 1 depicts a typical architecture for execution of an enterprise application;

FIG. 2 depicts a typical application server;

FIG. 3 depicts an application server implementing a Web Service Proxy;

FIG. 4A depicts an application server including management facilities implemented according to the teachings of embodiments of the management system described herein;

FIG. 4B depicts an application server including management facilities implemented according to the teachings of alternative embodiments of the management system described herein;

FIG. 5 depicts a computer system that may implement embodiments of the management system described herein; and

FIG. 6 depicts a flowchart according to the teachings of embodiments of the management system described herein.

### DETAILED DESCRIPTION

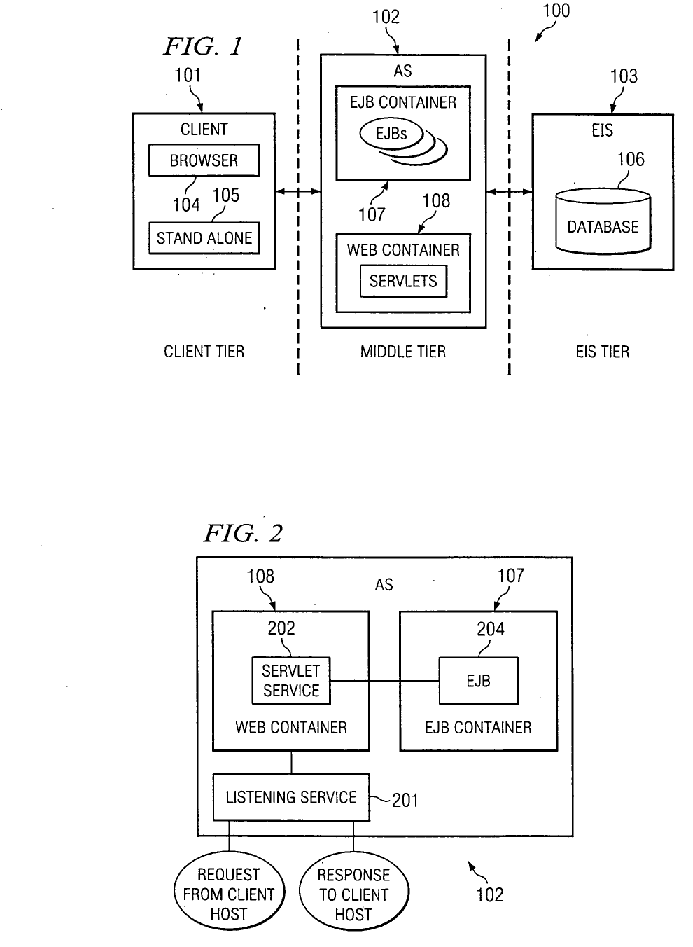

Before discussing the present invention in greater detail, it is appropriate to discuss the operations of the architecture that is typically utilized to implement enterprise applications. FIG. 1 depicts system 100 that may be utilized to implement enterprise applications. System 100 comprises client 101 in the client tier. Client 101 may comprise browser 104 to enable client 101 to access the enterprise applications. Alternatively, stand-alone application 105 may be implemented to access the enterprise applications in a proprietary manner if appropriate for the nature of the enterprise applications. The client tier is, in general, responsible for providing a user with the facilities (e.g., graphical user interfaces) that are necessary to interact with the applications on the middle tier. Enterprise Information System (EIS) 103 of the EIS tier may be implemented to manage the data utilized by the enterprise applications. EIS 103 may store the enterprise data in database 106 utilizing relational database management functionality as an example.

In the middle tier, Application Server (AS) 102 may interact with both client 101 and EIS 103. For example, AS 102 may comprise Enterprise JAVA Bean™ (EJB) container 107 to facilitate access to EIS 103. A container is a controlled run-time environment for an application component (e.g., an EJB) that also provides an interface to components executing within the container. Also, containers provide basic management functionality such as life cycle management of the components, security, deployment, threading, and/or the like. An EJB is a software component that implements the interfaces defined by its respective container. The interfaces of the EJB are defined in a manner that permits the functionality of the respective EJB to be accessed in a modular and dynamic manner. As shown in FIG. 1, AS 102 may also comprise Web container 108. Web container 108 may provide a controlled run-time environment for components that interact with client 101. For example, servlet components (persistent Web server processes that are capable of processing multiple requests) may be implemented to dynamically create hypertext markup language (HTML) or XML responses to requests from client 101. Other suitable components may be implemented within Web container 108.

In general, AS 102 (the middle tier) may be implemented utilizing “middleware servers” or “application servers.” An application server is typically comprised of many dissimilar services that are appropriate to create a stable and robust environment for enterprise applications. A service represents a predefined task that is provided by a piece of software in a well defined and predicable manner. Typically, an application server may comprise services that implement management functionality. The management services of the application server may be responsible for starting, registering, monitoring, and stopping services. Management services may perform other tasks such as thread pooling, security management, state management, class loading, load-balancing, dynamic application launching, and/or the like. Secondly, an application server may provide a basic set of services that may be commonly utilized by a wide range of enterprise applications (e.g., hypertext transfer protocol (HTTP) processing). Third, an application server may comprise application specific services that implement the business or other logic of a given enterprise application.

In general, the management functionality of an application server may enable an enterprise application to be implemented by binding the application specific services to more general services. For example, the management functionality may utilize a suitable deployment descriptor to create an HTTP listening service on a given port and to pass HTTP requests received from that port to an application specific service. The processing of the HTTP requests by the application specific service may then be managed by security services, event logging services, load-balancing services, and/or the like.

FIG. 2 depicts application server (AS) 102 that implements a typical enterprise application. AS 102 receives and processes requests from clients and returns responses to the respective clients. AS 102 may comprise listening service 201 to manage communication of the requests and responses. For example, a hypertext transfer protocol (HTTP) service may be defined to receive HTTP transactions on a defined port. Listening service 201 may pass the processed HTTP information to servlet service 202 that executes in Web container 108. Servlet service 202 may perform the application specific tasks. For example, servlet service 202 may generate HTML forms to facilitate communication of user specific information. Servlet service 202 may process the communicated user specific information. Servlet service 202 may then store the processed user specific information in a suitable database utilizing EJB 204 that is associated with EJB container 107.

The ability to create an enterprise application from a plurality of independent services is facilitated by defining standardized interfaces and contracts. Specifically, the standardized interfaces define collection of methods to be implemented by a class to expose the class to interaction within the application server environment. The contracts define special purpose interfaces that describe the syntax and semantics of class behavior. By defining interfaces and contracts in this manner, application server 102 may enable distinct services to interact thereby permitting programmatic solutions that are common to multiple business solutions to be assembled and reused for multiple applications.

Embodiments of the management system described herein depart from other application server designs, such as those described above, by permitting the management and monitoring of enterprise applications that leverage resources on remote systems while maintaining the same service architecture. By making remote management services locally accessible and by maintaining the service architecture, development of an application using remote services becomes advantageously manageable. Specifically, the security management services, logging services, and other services of the run-time environment may be leveraged to provide such facilities to the provision of remote services with reduced complexity. Thus, the complexity and unreliability of distributed Web service assembly may be remedied.

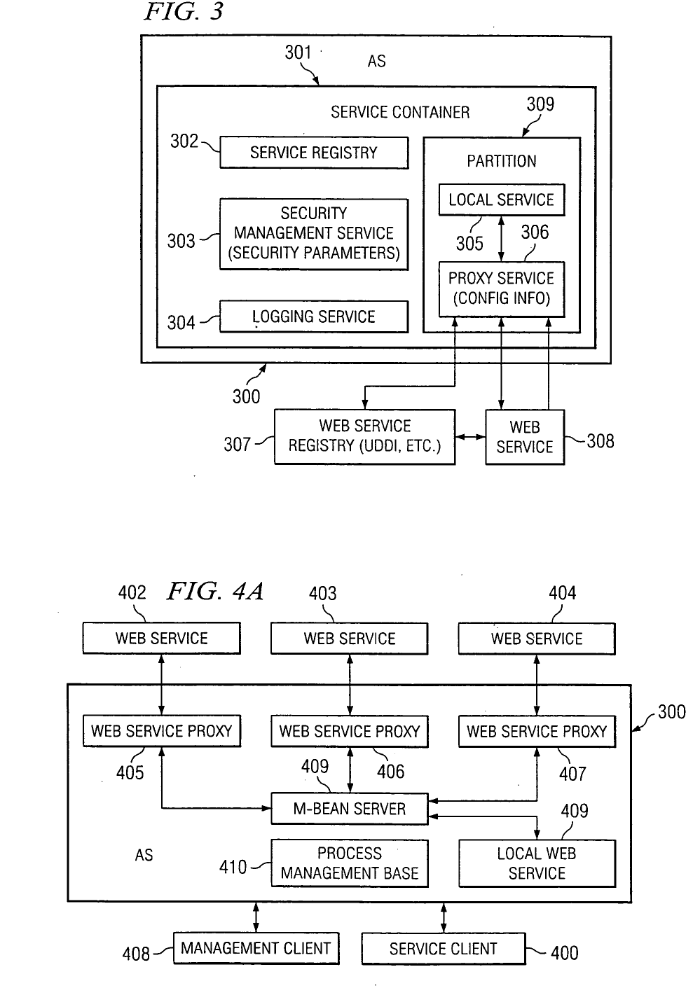

FIG. 3 depicts application server (AS) 300 that includes proxy service 306. AS 300 is configured according to the teachings of commonly-assigned, co-pending patent application Ser. No. ______, attorney docket number 100202433-1, entitled, “SYSTEMS AND METHODS FOR PROVIDING A SERVICE IN A CONTROLLED RUN-TIME ENVIRONMENT,” incorporated herein by reference. AS 300 enables a plurality of services to be assembled into enterprise applications. The enterprise applications (not shown) may execute in a controlled run-time environment such as container 301. The services executing within container 301 may be contained within respective partitions (e.g., partition 309) to limit the ability of the services to access the functionality of other services to the functionality assigned to a particular partition.

AS 300 may comprise service registry 302 to permit interoperation between services of enterprise applications. Specifically, processes that implement the defined interfaces of the controlled run-time environment may be registered in service registry 302 to expose their methods to other services. The other services may, in turn, examine service registry 302 to determine the availability of other services and to obtain an instance or handle to the interface of available services.

Additionally, AS 300, of the illustrated embodiment, includes various services that facilitate administration of enterprise applications. For example, AS 300 comprises security management service 303. Security management service 303 may be operable to perform authentication, authorization, administration, and auditing requirements. For example, security management process 303 may authenticate users before permitting access to enterprise applications and enforce user level or process level restrictions within executed enterprise applications according to security parameters. Also, AS 300, of the illustrated embodiment, comprises logging service 304. Logging service 304 may be operable when a service invokes a method of proxy service 306. Logging service 304 may, in response thereto, create a record of the calling service, the called service, the user context, the nature of the invoked method, any associated resources (e.g., files, communication addresses/ports, etc.), the time of the transaction, and/or the like. The recorded tracking information may be subsequently utilized to determine whether users are accessing appropriate resources and whether unauthorized individuals have compromised the security of an enterprise application. The logged information may be used to facilitate intrusion detection and “post-mortem” intrusion analysis.

AS 300, as described above, comprises proxy service 306. Proxy service 306 may comprise or be associated with configuration information. Proxy service 306 may utilize the configuration information to communicate with a WSDL repository 307 or any other suitable distributed service registry. Proxy service 306 may perform such communication to obtain an instance of Web service 308. Specifically, the instance of Web service 308 may be associated with an object on which methods may be invoked by proxy service 306. By invoking the methods in this manner, proxy service 306 may access the functionality of Web service 308. In embodiments according to the teachings herein, proxy service 306 may utilize JAX-RPC to invoke the methods of Web service 308. Also, the methods may communicate the method argument(s) and returned argument(s) utilizing suitable protocols such as XML according to the SOAP specification.

As previously noted, AS 300 comprises service registry 302 to enable processes to expose their methods to other services. In embodiments according to the teachings herein, proxy service 306 may be registered in service registry 302. Other services, such as local service 305, may utilize the information contained in service registry 302 to access the exposed methods. Accordingly, local service 305 may invoke an appropriate method or methods of proxy service 306 in the same manner as invoking a method of any other service executing within the controlled run-time environment of service container 301. When a method of proxy service 306 is invoked, method arguments may be communicated. Utilizing the communicated information, proxy service 306 may determine whether the arguments are appropriate given the method called. If so, proxy service 306 may invoke a corresponding method of Web service 308 utilizing, for example, the method arguments communicated by local service 305. Proxy service 306 may manage the communication of information with Web service 308 according to the respective communication protocols associated with Web service 308. When the information is received by the method of Web service 308, the method may process the information as appropriate (e.g., perform a database transaction). The method may return any appropriate information (e.g., an object containing the results of the database transaction) to proxy service 306. Proxy service 306 may communicate the returned information to local service 305.

The architecture of e-services, with a complete application offering comprising a combination of a number of local and remote Web services may be analogized to a computer network with each network component being one of the Web services. Considering this architectural analogy, the management of such various Web services integrated into a single “system” is similar to the management of a computer network. Network management tools, such TIVOLI'S BUSINESS SYSTEMS MANAGER™ and COMPUTER ASSOCIATES' UNICENTER™, were developed to maintain and monitor the complexities of such computer networks. Such network management tools are pervasive throughout many enterprises for managing and monitoring the enterprises' computer networks. These tools leverage standardized formats, such as Simple Network Management Protocol (SNMP), remote monitor (RMON), and the like, and the management information base (MIB) data, which defines standard classes of device attributes and administration interfaces, to create a standardized management protocol.

With the increase in Web service availability, the need for software process management, along the lines of network management, also increases, as software “systems” begin extending to execution of remote Web services. One process management tool that begins to address this need is SUN MICROSYSTEM's JAVA™ MANAGEMENT EXTENSIONS (JMX), which allows JAVA™ developers to integrate their applications with existing network management solutions, such as TIVOLI'S BUSINESS SYSTEMS MANAGER™ and COMPUTER ASSOCIATES' UNICENTER™. JMX defines a standard for writing process management objects, called management beans (m-beans) in the JMX tool. Like any other managed object, an m-bean has a set of properties, can perform a set of process management services or resources, and can emit a set of notifications, most of which address process management information. With m-beans, management applications may be developed for providing methods that produce management information about any given object or Web service. M-beans exist inside a container defined by the JMX standard. Therefore, it allows a JMX client to invoke methods and access attributes on an m-bean using that container. M-beans may also transmit notifications to a client after the client registers with the m-bean. It should be noted that while the discussions of the embodiments of the present invention use the JMX standard, the teachings of the different embodiments of the present invention are, in no way, limited only to implementation in JMX.

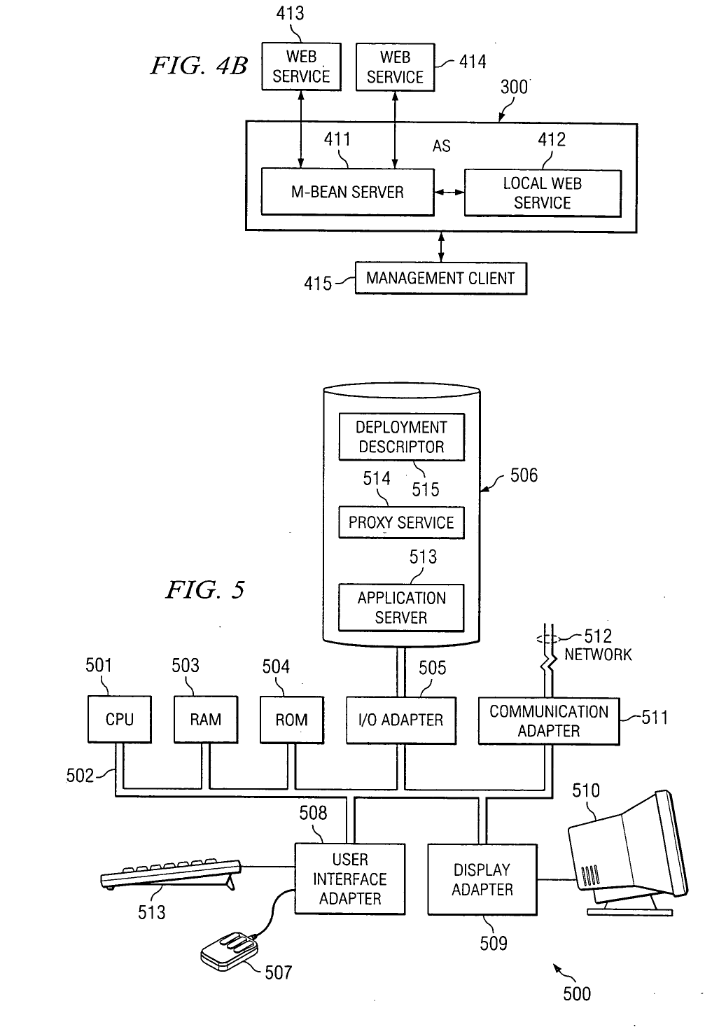

FIG. 4A depicts an application server including management facilities implemented according to teachings of embodiments of a management system described herein. In general application, service client 400 will invoke an application from application server (AS) 300. The application represented in FIG. 4A may comprise a combination of Local Web Service 401 and remote Web services 402-404. AS 300 has been configured according to the teachings of commonly-assigned, co-pending patent application Ser. No. ______, attorney docket number 100202433-1, entitled, “SYSTEMS AND METHODS FOR PROVIDING A SERVICE IN A CONTROLLED RUN-TIME ENVIRONMENT,” by incorporating Web service proxies 405-407. Therefore, according to one embodiment, as service client 400 calls the application, AS 300 executes and calls the functionality provided, not only by local Web service 401, but also by remote Web services 402-404. AS 300 facilitates the remote procedure calls to Web services 402-404 by interacting with Web service proxies 405-407. Web service proxy 405, for example, will provide the method interface between AS 300 and Web service 402. Any functionality or information provided by Web service 402 will preferably be provided to AS 300 through a resource interface, such as Web service proxy 405.

The provider of the application (not shown) may wish to monitor process management information on the application that may provide insight into the success or failure of the application. To do so, the application provider may access AS 300 through management client 408. In addition to Web service proxies 405-407, AS 300 includes process management object servers, such as m-bean server 409. A process management object server provides a management resource registry for the available distributed process management services or resources. As Web services 402-404 register with Web service proxies 405-407, they also preferably register their m-beans with m-bean server 409 or other such management object server through Web service proxies 405-407.

In operation, management client 408 issues a request for a process management resource to AS 300. Within AS 300, m-bean server 409 looks up in a table or resource registry to find out where the requested resource is located. If the resource were located at Web service 402, m-bean server 409 would issue the request to Web service proxy 405 which would then request execution of the process management resource on Web service 402. After execution, the process management information is returned to m-bean server 409 through Web service proxy 405. M-bean server 409 may either communicate the resulting management information directly to management client 408 automatically, or through some kind of request, or in alternative embodiments, may store the management information in a management resource registry, such as process management base 410.

FIG. 4B depicts application server 300 including management facilities implemented according to the teachings of alternative embodiments of the management system described herein. Application server 300 includes m-bean server 411, which contains management information objects, such as m-beans, registered for local Web service 412, and remote Web services 413-414. Instead of implementing the management service through a Web service proxy, as shown in FIG. 4A, m-bean server 411 is configured using communication code to interface with the m-beans at Web services 413-414 directly through some kind of remote procedure call or the like. Therefore, as management client 415 attempts to access one or more of the management methods of the m-beans from Web service 412 and/or Web services 413-414, management client 415 communicates with m-bean server 411, which may then either call the method from local Web service 412 or from remote Web services 413-414, depending on where the m-bean is located.

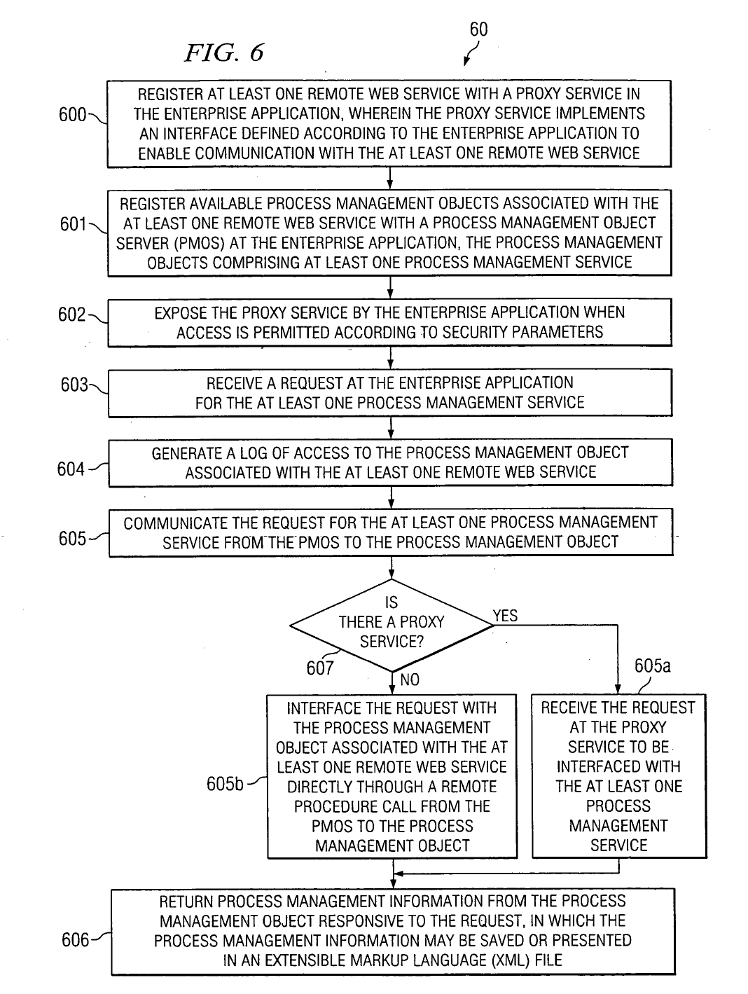

When implemented via executable instructions, various elements of the present invention are in essence the code defining the operations of such various elements. For example, the process flow of FIG. 6 may be implemented utilizing executable instructions or code The executable instructions or code may be obtained from a readable medium (e.g., hard drive media, optical media, EPROM, EEPROM, tape media, cartridge media, and/or the like) or communicated via a data signal from a communication medium (e.g., the Internet). In fact, readable media can include any medium that can store or transfer information.

FIG. 5 illustrates computer system 500 adapted according to representative embodiments of the management system described herein. Central processing unit (CPU) 501 is coupled to system bus 502. CPU 501 may be any general purpose CPU. However, the present invention is not restricted by the architecture of CPU 501 as long as CPU 501 supports the inventive operations as described herein.

Computer system 500 also includes random access memory (RAM) 503, which may be SRAM, DRAM, SDRAM, or the like. Computer system 500 includes ROM 504 which may be PROM, EPROM, EEPROM, or the like. RAM 503 and ROM 504 hold user and system data and programs as is well known in the art.

Computer system 500 also includes input/output (I/O) adapter 505, communications adapter 511, user interface adapter 508, and display adapter 509. I/O adapter 505 connects to storage devices 506, such as one or more of hard drive, CD drive, floppy disk drive, tape drive, to computer system 500. The storage media associated with storage devices 506 may store executable instructions according to embodiments of the present invention. For example, the executable instructions defining application server 513 may be stored on the media. Also, deployment descriptor 515 may be stored on the media to enable application server 513 to load and manage the various services that constitute the enterprise applications. The various services may include proxy service 514. The executable instructions defining the operations of proxy service 514 may also be stored on the media associated with storage devices 506.

Communications adapter 511 is adapted to couple computer system 500 to a network 512, which may be one or more of telephone network, local (LAN) and/or wide-area (WAN) network, Ethernet network, and/or Internet network. User interface adapter 508 couples user input devices, such as keyboard 513 and pointing device 507, to computer system 500. Display adapter 509 is driven by CPU 501 to control the display on display device 510.

FIG. 6 depicts flowchart 60 according to the teachings of embodiments of a management system described herein. Embodiments of the present invention may include at least one remote Web service that is registered with a proxy service in the enterprise application, wherein the proxy service implements an interface defined according to the enterprise application to enable communication with the at least one remote Web service in step 600. In step 601, available process management objects associated with the at least one remote Web service are registered with a process management object server (PMOS) at the enterprise application, the process management objects comprising at least one process management service. In the embodiments incorporating a proxy service, the proxy service is exposed by the enterprise application when access is permitted according to security parameters in step 602. In step 603, a request is received at the enterprise application for the at least one process management service. In various embodiments of the management system described herein, a log of access to the process management object associated with the at least one remote Web service may be generated in step 604. The request for the at least one process management service is communicated from the PMOS to the process management object in step 605. Depending on the embodiment implemented, a determination is made in step 607 whether the request may be received, in step 605a, at the proxy service to be interfaced with the at least one process management service. Alternatively, in step 605b, the request may be interfaced with the process management object associated with the at least one remote Web service directly through a remote procedure call from the PMOS to the process management object. In step 606, process management information is returned from the process management object responsive to the request, in which the process management information may be saved or presented in an Extensible Markup Language (XML) file.

1. A method for providing process management services in an enterprise application comprising at least one remote Web service, said method comprising:
registering available process management objects associated with said at least one remote Web service with a process management object server (PMOS) at said enterprise application, said process management objects comprising at least one process management service;
receiving, at said enterprise application, a request for said at least one process management service;
communicating, from said PMOS, said request for said at least one process management service to said process management object; and
returning process management information from said process management object responsive to said request.

2. The method of claim 1 further comprising:
registering said at least one remote Web service with a proxy service in said enterprise application, wherein said proxy service implements an interface defined according to said enterprise application to enable communication with said at least one remote Web service;
wherein said communicating includes:
receiving, at said proxy service, said request for said at least one process management service; and
interfacing said request with said process management object associated with said at least one remote Web service.

3. The method of claim 2 further comprising:
exposing, by said enterprise application, said proxy service when access is permitted according to security parameters.

4. The method of claim 1 further comprising:
generating a log of access to said process management object associated with said at least one remote Web service.

5. The method of claim 1 further comprising:
encapsulating said process management information in an Extensible Markup Language (XML) file.

6. The method of claim 1 wherein said communicating includes:
performing a remote procedure call from said PMOS to said process management object associated with said at least one remote Web service.

7. A system for providing process management resources to an application implementing distributed services comprising:
a controlled run-time environment within said application controlling execution of said distributed services;
a management resource registry for registering distributed process management resources associated with said distributed services; and
a resource interface enabling communication between said application and said distributed process management resources.

8. The system of claim 7 wherein said resource interface comprises one of:
a proxy service within said application configured to communicate with a predetermined one of said distributed services; and
communication code within said management resource registry for executing a remote procedure call to said distributed services.

9. The system of claim 7 further comprising:
a process management base for storing process management information received from said distributed process management resources responsive to a request for said process management information.

10. The system of claim 9 wherein said process management information is stored in an Extensible Markup Language (XML) format.

11. The system of claim 7 further comprising:
a security application for controlling access to said resource interface.

12. The system of claim 7 further comprising:
a tracking application for logging accesses to said resource interface.

13. A computer program product having a computer readable medium with computer program logic recorded thereon, said computer program product comprising:
code for registering available management information objects (MIOs) disposed in one or more remote Web services with a management object server (MOS) in an enterprise application, said MIOs comprising at least one process management service;
code for receiving a request for said at least one process management service at said MOS;
code for communicating said request for said at least one process management service from said MOS to said MIOs; and
code for returning management information to said MOS responsive to said request.

14. The computer program product of claim 13 further comprising:
code for registering said one or more remote Web services with a proxy service in said enterprise application, wherein said proxy service implements an interface defined according to said enterprise application to enable communication with said one or more remote Web services;
wherein said code for communicating includes:
code for receiving said request for said at least one process management service at said proxy service; and
code for interfacing said request with said MIOs disposed in said one or more remote Web services.

15. The computer program product of claim 14 further comprising:
code for exposing said proxy service when access is permitted according to security parameters implemented by said enterprise application.

16. The computer program product of claim 13 further comprising:
code for generating a log of access to said MIOs associated with said one or more remote Web services.

17. The computer program product of claim 13 further comprising:
code for encapsulating said management information in an Extensible Markup Language (XML) file.

18. The computer program product of claim 13 wherein said code for communicating includes:
code for performing a remote procedure call from said MOS to said MIOs disposed in one or more remote Web service.
